(19) United States
(12) Patent Application Publication
(10) Pub. No.: US 2025/0124612 A1
(43) Pub. Date: Apr. 17, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yu HASHIMOTO, Kanagawa (JP)

(21) Appl. No.: 18/903,853

(22) Filed: Oct. 1, 2024

(30) Foreign Application Priority Data
Oct. 13, 2023 (JP) 2023-177599

(51) Int. Cl. G06T 11/00

(52) U.S. Cl. CPC G06T 11/00

(57) ABSTRACT

An information processing apparatus is disclosed that includes at least one memory configured to store instructions, and at least one processor that, upon execution of the stored instructions, causes the at least one processor to receive input of person information representing a person and location information representing a location, generate a prompt based on the inputted person information and the inputted location information, acquire an image representing the person and the location by causing an image-generation model to generate the image based on selection of the generated prompt, wherein the image-generation model may be hosted on an image generation server, and output the image.

### BACKGROUND

### Field

The present disclosure relates to an information processing apparatus, an information processing method, and a storage medium.

### Description of the Related Art

In recent years, a service that is so-called generative artificial intelligence (AI) has come into a practical use stage. Japanese Patent Application Laid-open No. 2023-126068 discusses a technique of performing image generation using generative adversarial networks (GANs) based on an image generation request including a text or the like for an image generation condition or an image generation.

An image generation technique of generating an image in which a person's face image is replaced by another person's face image is discussed, and is being used for various uses such as entertainment, and learning and evaluation data in AI development. Japanese Patent Application Laid-open No. 2021-73619 discusses a technique of clipping a face region of a second face image to match a face region of a first face image when the second face image is fit in the first face image.

### SUMMARY

According to an aspect of the present disclosure, an information processing apparatus includes at least one memory configured to store instructions, and at least one processor that, upon execution of the stored instructions, causes the at least one processor to receive input of person information representing a person and location information representing a location, generate a prompt based on the inputted person information and the inputted location information, acquire an image representing the person and the location by causing an image-generation model to generate the image based on selection of the generated prompt, wherein the image-generation model may be hosted on an image generation server, and output the image.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus.

FIG. 2 is a block diagram illustrating an example of a functional configuration of the information processing apparatus.

FIG. 3 is a diagram illustrating an example of an input screen.

FIG. 4 is a flowchart illustrating a processing flow of the information processing apparatus.

FIG. 5 is a flowchart illustrating a processing flow performed by an image correction unit.

FIG. 6 is a diagram illustrating examples of images before and after the processing by the image correction unit.

### DESCRIPTION OF THE EMBODIMENTS

The present disclosure will be described in detail based on exemplary embodiments of the present disclosure with reference to the attached drawings. Note that configurations described in the following exemplary embodiments are merely examples, and the present disclosure is not limited to the illustrated configurations.

In a first exemplary embodiment, an example of a case where an information processing apparatus 100 generates an image for searching for a missing person (search target) will be mainly described. In a conventional search, there is a case where the search is conducted only based on information by word of mouth about a face and appearance of the search target. However, the images of words differ depending on persons, and it is difficult to appropriately catch an image of the search target. There is a case where a facial composite or a photo-montage of the search target is generated, but it requires time and resources. The search request client may have a picture (image) of the search target, but there is a possibility that an enough search efficiency cannot be obtained in a case where a scenery in the picture and a scenery in a search field are different.

The information processing apparatus 100 according to the present exemplary embodiment acquires an image suitable for searching, based on person information about the search target and location information about the search field.

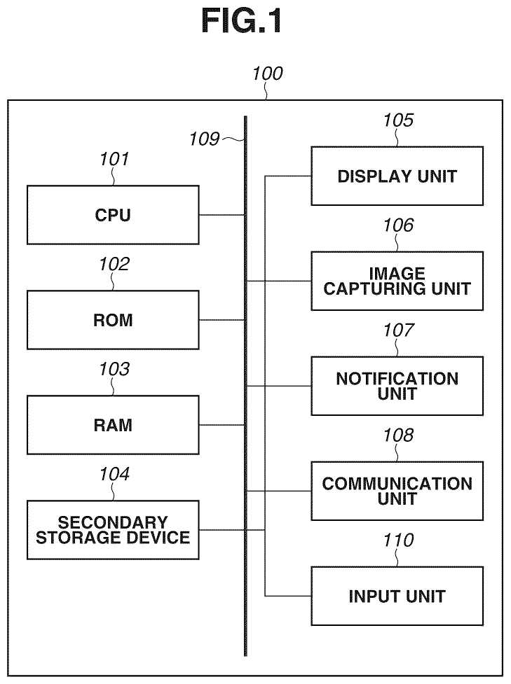

FIG. 1 is a block diagram illustrating a hardware configuration of the information processing apparatus 100 according to the present exemplary embodiment. As illustrated in FIG. 1, the information processing apparatus 100 includes a central processing unit (CPU) 101, a read only memory (ROM) 102, a random access memory (RAM) 103, a secondary storage device 104, a display unit 105, an image capturing unit 106, a notification unit 107, a communication unit 108, a bus 109, and an input unit 110.

The CPU 101 executes instructions according to a program stored in the ROM 102 or the RAM 103. The ROM 102 is a non-volatile memory to store programs for the present disclosure, and programs and data required for other controls. The RAM 103 is a volatile memory to temporarily store data such as image data and sensor information. The secondary storage device 104 is a secondary storage device, such as a hard disk drive and a flash memory, to store image data, programs, and various setting contents. These pieces of information are transferred to the RAM 103 and used by the CPU 101.

The display unit 105 performs display control to display various pieces of data, processing results, and images on a display device. The image capturing unit 106 includes an imaging lens, an image sensor such as a complementary metal-oxide semiconductor (CMOS) sensor, an image signal processing unit, and the like to capture a still image and a video image. The notification unit 107 is a device composed of a speaker or the like, to provide a notification to a user using sound. The communication unit 108 is a modem, a local area network (LAN), or a Wi-Fi network for connecting to a network such as the Internet and an intranet. The bus 109 connects the above-described devices to input and output data to and from each other. The input unit 110 receives inputs from, for example, a mouse, a keyboard, a touch panel, and a scanner.

The configuration of the above-described information processing apparatus 100 is merely an example, and various modification examples can be employed. For example, the information processing apparatus 100 does not necessarily include the image capturing unit 106. The information processing apparatus 100 does not necessarily include the notification unit 107. The information processing apparatus 100 may be integrated with the display device, and the information processing apparatus 100 and the display device may be connected via an interface.

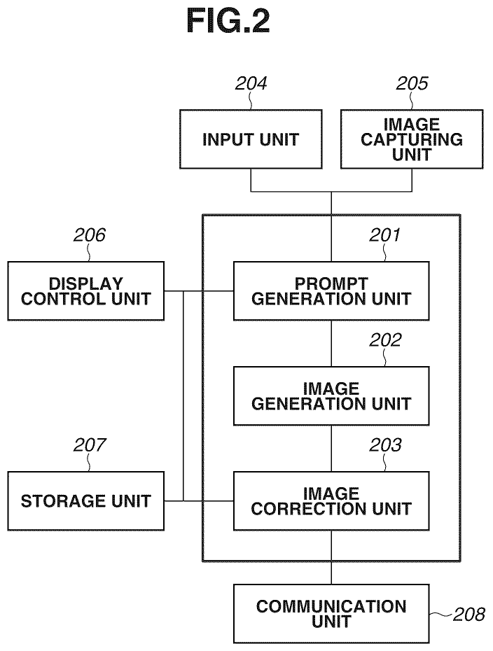

With reference to FIG. 2, a functional configuration of the information processing apparatus 100 will be described. As illustrated in FIG. 2, the information processing apparatus 100 includes a prompt generation unit 201, an image generation unit 202, an image correction unit 203, an input unit 204, an image capturing unit 205, a display control unit 206, a storage unit 207, and a communication unit 208.

The prompt generation unit 201 generates a prompt for image generation based on information input from the input unit 110 and/or the image capturing unit 106. The prompt generation unit 201 will be described in detail below.

The image generation unit 202 generates an image based on selection of the prompt generated by the prompt generation unit 201. The image generation unit 202 generates the image for selection by using the prompt based on a known image generation technique such as a GAN, a Variational Auto-Encoder (VAE), and a Convolutional Neural Network (CNN). Instead of the information processing apparatus 100 generating the image, the image may be generated by an image generation server connected to the information processing apparatus 100 via the Internet or another network. In this case, the image generation unit 202 transmits the prompt to the image generation server via the communication unit 108 to acquire an image generated by the image generation server, as a response thereof. In either case, the image generation unit 202 acquires the image for selection using the prompt, with the image being generated by the prompt generation unit 201. Details of the image generation unit 202 will be described below.

The image correction unit 203 performs processing of replacing a face image of a person in the generated image acquired by the image generation unit 202 with a face image designated by a user. Details of the image correction unit 203 will be described below.

The input unit 204 and the image capturing unit 205 input various kinds of information to be used for generating a prompt, to the prompt generation unit 201. The display control unit 206 displays various kinds of data such as the prompt generated by the prompt generation unit 201 and the generated image corrected by the image correction unit 203, on the display unit 105 (display device). The storage unit 207 stores various kinds of data such as the prompt generated by the prompt generation unit 201 and the generated image corrected by the image correction unit 203, in the secondary storage device 104 (storage device). The communication unit 208 outputs the prompt and the generated image to other devices such as a display device and a printer.

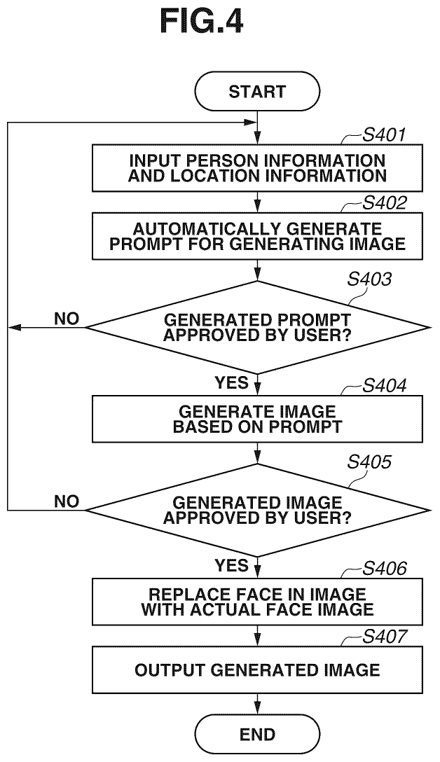

With reference to a flowchart in FIG. 4, operations of the information processing apparatus 100 according to the present exemplary embodiment will be described. The information processing apparatus 100 executes various kinds of processing illustrated in FIG. 4 by the CPU 101 reading out a program stored in the ROM 102 into the RAM 103, and executing the read program. The various kinds of processing illustrated in FIG. 4 are started by a user instructing a generation of an image according to the present exemplary embodiment.

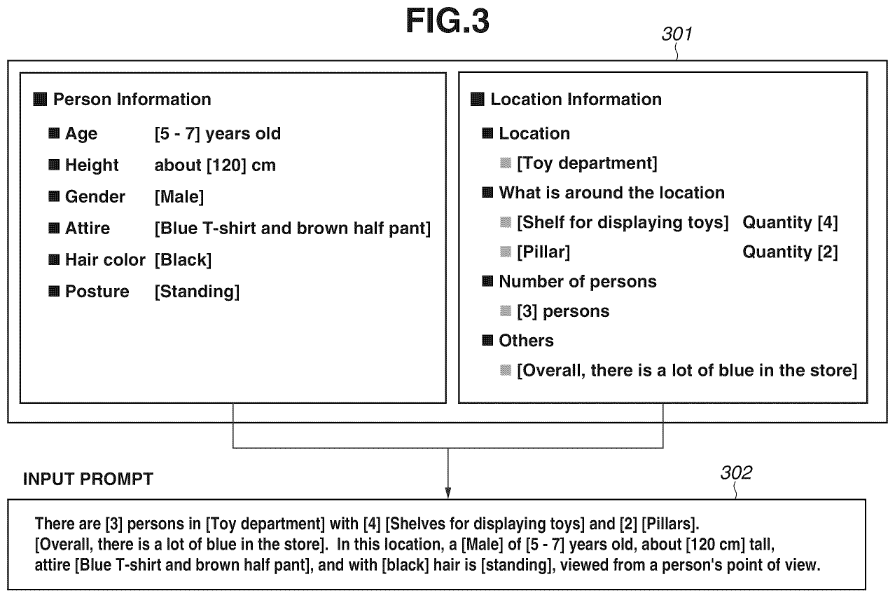

In step S401, the input unit 204 and/or the image capturing unit 205 input person information representing a specific person (search target), and location information representing a location, to the prompt generation unit 201. FIG. 3 illustrates an example of an input screen for inputting the person information and the location information. As illustrated in FIG. 3, an input screen 301 includes an area for inputting the person information and an area for inputting the location information.

The area for inputting the person information includes items for inputting at least one of a person's age, height, gender, attire, hair color, and posture, and the input of the person information can be completed by inputting the information in the brackets ([ ]). As a non-limiting example, the area for inputting the location information may include items for inputting a location type (e.g., [toy department]), an object type, and the number of objects (e.g., [four shelves for displaying toys], and [two pillars]), the number of persons, and other information.

The person information and the location information are not limited to the examples in FIG. 3. For example, information such as a length of hair, a color of skin, a color of eyes, and a body shape may be included as the person information. For example, the location information may include information about a type of person (e.g., shop staff, pedestrian, or customer) to be included in the generated image, and a congestion situation, and information such as colors of a wall and a ceiling. By having a user input the person information and the location information using a format such as the input screen 301 in FIG. 3, a user can input various kinds of information simply and conveniently without any omissions.

The acquisition method of the person information and the location information is not limited to the acquisition method of manually inputting various kinds of information to the input screen 301. For example, the person information and the location information may be input using an image captured by the image capturing unit 205. More specifically, a part of or all of the location information in the input screen 301 may be automatically input based on an analysis result of the captured image acquired by capturing the image of a search field by the image capturing unit 205. The captured image itself may be input to the prompt generation unit 201 as the location information.

If the secondary storage device 104 stores the image of the search target, a part of or all of the person information in the input screen 301 may be automatically input based on the analysis result of the image. The image of the search target stored in the secondary storage device 104 itself may be input to the prompt generation unit 201 as the person information. In this way, the person information and the location information can be input more simply and conveniently.

In step S402, the prompt generation unit 201 generates a prompt for image generation based on the person information and the location information. An input prompt 302 in FIG. 3 is an example of a prompt automatically generated based on the person information and the location information displayed on the input screen 301.

In step S403, the display control unit 206 displays the prompt on the display device to have a user check whether the prompt is a prompt intended by the user. In a case where the user approves the prompt generated in step S402 (YES in step S403), the processing proceeds to step S404. On the other hand, in a case where the user disapproves (i.e., change instruction is received) the generated prompt (NO in step S403), the processing returns to step S401. In a case where the processing returns to step S401, the display control unit 206 displays the input screen 301 as an information change screen. A user can perform edit operations such as addition, change, and deletion of the person information and the location information displayed on the input screen 301 in FIG. 3. The processing in steps S401 to S403 can be repeated until the prompt becomes the prompt intended by the user. The processing may return to step S401 to receive the editing operations on the input prompt 302 in FIG. 3, instead of receiving the editing operations of the person information and the location information. The processing in step S403 is not essential.

In step S404, the image generation unit 202 acquires the generated image based on the prompt generated by the prompt generation unit 201. The image generation unit 202 acquires the image based on the prompt using a known image generation technique such as a GAN, a VAE, and a CNN. Thus, the image generation unit 202 acquires the generated image by inputting the prompt to a trained program trained to generate the image corresponding to the prompt. The image acquired by the image generation unit 202 is an image including the person indicated by the person information, and representing the location indicated by the location information. Upon completing the acquisition of the generated image, the processing proceeds to step S405.

In step S405, the display control unit 206 displays the generated image on the display device to have a user check whether the generated image is an image intended by the user. In step S405, in a case where the user approves the generated image acquired in step S404 (YES in step S405), the processing proceeds to step S406. On the other hand, in a case where the user disapproves the generated image (NO in step S405), the processing returns to step S401. In a case where the processing returns to step S401, the user can add, change, and delete the person information and the location information displayed on the input screen 301 in FIG. 3. The processing in steps S401 to S405 can be repeated until the generated image becomes the image intended by the user.

In step S406, the image correction unit 203 executes replacement processing of replacing a face image included in the generated image with a designated face image. Thus, the face image drawn based on the person information is replaced by the face image of the search target. In this way, the image when the search target is in the search field is generated.

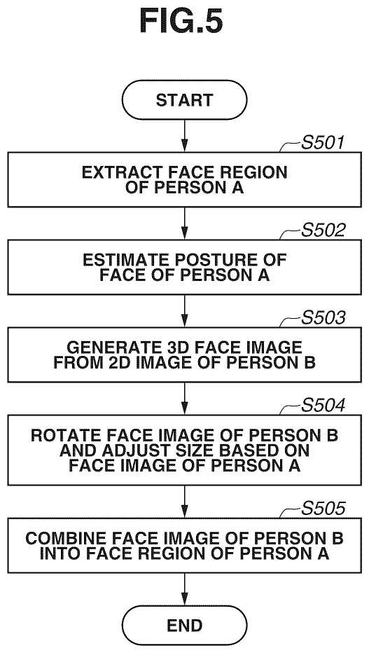

FIG. 5 is a flowchart illustrating details of the processing in step S406 in FIG. 4. In step S501, the image correction unit 203 extracts a face region of a person A from the generated image. The person A is a person drawn in the generated image based on the person information. As a detection method of the face region, a known method can be used, such as a method of detecting the face region from an image feature amount such as a Haar base feature applying an object recognition, and an object detection method using a deep learning.

In step S502, the image correction unit 203 estimates a posture (orientation and angle) of a face of the person A. The estimation of the posture of the face is achieved by using a model trained by the deep learning using a learning image set including an image whose posture of the face is identified in advance and a value of the posture of the face, as a set. By inputting an image into the model trained in this way, the posture of the face can be acquired as an output.

In step S503, the image correction unit 203 generates a three-dimensional (3D) face image from an image of a designated person (person B). This is achieved by using a deep leaning model that outputs a parameter for deforming a 3D mesh model based on a shade and shadow of a face image and a layout relationship between parts of a face. The image correction unit 203 can generate a face image with a desired posture and size by three-dimensionally designating the posture and the size after generating a mesh model and mesh data with texture of the face obtained from the captured image. As another method, it is possible to generate a 3D face image by using a deep learning model for generating an image with a face turning to a direction different from an image with a face turning forward. A known image generation technique such as a CNN can be used for this method.

In step S504, the image correction unit 203 rotates the face image of the person B based on the posture of the face of the person A, and adjusts the size of the face image of the person B based on the face image of the person A. The adjustment processing can be achieved by a known method using a rigid transformation matrix for transferring the above-described 3D mesh data with texture to a designated coordinate system.

In step S505, the image correction unit 203 combines the face image of the person B into the face region of the person A. The image correction unit 203 can achieve the image combining using a known method such as a method of setting areas other than the face to be a specific mask designation color such as green, and a method of setting the face and other organs distinguishable in an a blending data area. By the processing in step S505, a more natural generated image can be acquired. More specifically, the image including the face of the search target matching the orientation and size of the face in the generated image generated in step S404 can be generated.

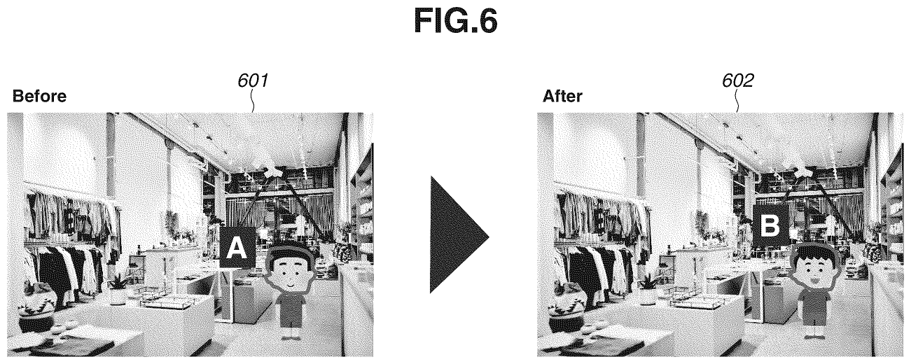

FIG. 6 illustrates a generated image 601 generated in step S404, and a generated image 602 after the replacement processing in step S406. As illustrated in FIG. 6, the face region (person face automatically generated based on person information) of the person A included in the generated image 601 is replaced by the face image of the person B designated by a user.

In the present exemplary embodiment, the example of replacing the face image after the generated image is generated from the prompt is described, without being limited to this example. For example, in step S404, the generated image may be generated based on the person information, the location information, and the face image of the search target. In a case where a search request client has an entire body image of the search target, the generated image may be generated based on the person information, the location information, and the entire body image of the search target.

The image generated in step S406 can be output via the communication unit 208 in step S407, to be displayed on a device different from the information processing apparatus 100, or to be printed out by a printer. The generated image can be shared by a device or a system of a person who needs the generated image. For example, the generated image can be delivered to smartphones of shop staff members or security staff members. In this way, involved parties can immediately grasp the image of the search target.

In the present exemplary embodiment described above, the description is mainly given of the example case of inputting the person information and the location information as text on the input screen 301 as illustrated in FIG. 3, but the person information and the location information may be input via an image. For example, it is possible to acquire an image of a location where the search target is estimated to be present from the image capturing unit 106 such as a monitoring camera, detect an object from the image using a known deep learning technique such as a “Region Based Convolutional Neural Networks” (R-CNN) and a “You Only Look Once” (YOLO), and input the detection result as information for generating a prompt. The location information may be input not only from the image captured by the image capturing unit 106 but also from various kinds of images such as an image stored in the secondary storage device 104 in advance, and an image acquired via the Internet. It is also possible to input the person information as information for generating a prompt by extracting gender information or profile information as text data from an image of the search target.

The information processing apparatus 100 according to the present exemplary embodiment can store the generated image generated in step S406 in FIG. 4 into the secondary storage device 104, and transmit the stored generated image to another device at an arbitrary timing via the communication unit 108. Thus, the information processing apparatus 100 can share the generated image with searchers at an arbitrary timing, and print out the generated image using a printer to deliver the printed generated image to the searchers. In this way, it is possible to promptly conduct the search operation. It is also possible to cooperate with a service connected to the Internet to use the generated image for various uses.

In the exemplary embodiment described above, the description is mainly given of the example case of generating the prompt based on the person information about the search target and the location information about the search field, and acquiring the image suitable for search, without being limited to the example. For example, the information processing apparatus 100 according to the present exemplary embodiment can generate an image suitable to be uploaded based on any person information designated by an uploading user who uploads the image to a Social Networking Service (SNS), and location information representing a scenery in the image. The information processing apparatus 100 can generate an image using, for example, product information about a product to be promoted, instead of the person information. In this case, the information processing apparatus 100 also can generate an image for promotion based on the product information and the location information to be displayed as a background of the product. In addition, there are various kinds of variations in use pattern and use objective of the generated image, such as generating a generated image for assisting a certain work, and generating a generated image for developing software or the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-177599, filed Oct. 13, 2023, which is hereby incorporated by reference herein in its entirety.

What is claimed is:

1. An information processing apparatus comprising:
at least one memory configured to store instructions; and
at least one processor that, upon execution of the stored instructions, causes the at least one processor to:
receive input of person information representing a person and location information representing a location;
generate a prompt based on the inputted person information and the inputted location information;
acquire an image representing the person and the location by causing an image-generation model to generate the image based on selection of the generated prompt, wherein the image-generation model may be hosted on an image generation server; and
output the image.

2. The information processing apparatus according to claim 1, wherein the person information includes at least any one of age, height, gender, attire, hair color, or posture of the person to be included in the generated image.

3. The information processing apparatus according to claim 1, wherein the location information includes at least any one of a type of location to be represented by the generated image, a type and number of objects to be included in the generated image, and a number of persons to be included in the generated image.

4. The information processing apparatus according to claim 1,
wherein the stored instructions cause the at least one processor to:
display the generated prompt on a display device;
receive a change instruction for changing the prompt displayed on the display device; and
re-generate the image based on selection of the displayed changed prompt.

5. The information processing apparatus according to claim 4,
wherein a change screen for changing the person information and the location information is displayed on the display device, in a case where the change instruction is received, and
wherein the image is re-generated based on selection of the displayed changed prompt.

6. The information processing apparatus according to claim 4, wherein the change instruction is an edit operation performed on the prompt displayed on the display device.

7. The information processing apparatus according to claim 1, wherein the instructions cause the at least one processor to:
display the generated image on a display device; and
receive a change instruction to change the generated image displayed on the display device.

8. The information processing apparatus according to claim 1,
wherein the instructions cause the at least one processor to replace a face image of the person included in the generated image with a designated face image, and
wherein another image is generated by replacing the face image with the designated face image and is output.

9. The information processing apparatus according to claim 1, wherein the generated image is output to a display device and/or a printer.

10. The information processing apparatus according to claim 1, wherein the generated image is acquired by inputting the generated prompt to a program trained to generate an image corresponding to the prompt.

11. The information processing apparatus according to claim 1, wherein the person information and the location information are input as at least any one of text data and image data.

12. An information processing method performed by an information processing apparatus, the information processing method comprising:
receiving input of person information representing a person and location information representing a location;
generating a prompt based on the inputted person information and the inputted location information;
acquiring an image representing the person and the location by causing an image-generation model to generate the image based on selection of the generated prompt, wherein the image-generation model may be hosted on an image generation server; and
outputting the image.

13. The information processing method according to claim 12, further comprising:
displaying the generated prompt on a display device;
receiving a change instruction for changing the prompt displayed on the display device; and
re-generating the image based on selection of the displayed changed prompt.

14. The information processing method according to claim 12, further comprising:
replacing a face image of the person included in the generated image with a face image designated in advance; and
outputting the generated replacement image by replacing the face image with the advance designated face image.

15. A non-transitory computer-readable storage medium configured to store a program for causing a computer to execute an information processing method comprising:
receiving input of person information representing a person and location information representing a location;
generating a prompt based on the inputted person information and the inputted location information;
acquiring an image representing the person and the location by causing an image-generation model to generate the image based on selection of the generated prompt, wherein the image-generation model may be hosted on an image generation server; and
outputting the image.
